(19) United States
(12) Patent Application Publication
(10) Pub. No.: US 2007/0109552 A1
(43) Pub. Date: May 17, 2007

(54) Optical interferometer

(76) Inventors: Greg C. Felix, San Jose, CA (US); John Bockman, Santa Clara, CA (US)

Correspondence Address: AGILENT TECHNOLOGIES INC., INTELLECTUAL PROPERTY ADMINISTRATION,LEGAL DEPT., MS BLDG. E P.O. BOX 7599, LOVELAND, CO, 80537, US

(21) Appl. No.: 11/266,542

(22) Filed: Nov. 3, 2005

(51) Int. Cl. G01B 9/02

(52) U.S. Cl. 356/491

(57) ABSTRACT

An optical interferometer includes a monolithic optical element.

### BACKGROUND

Optical interferometers are useful in exacting precise measurements. For example, optical interferometers are used to determine movement of optical elements used in photolithographic processing of semiconductor wafers, where precision on the order of nanometers (10⁻⁹ m) and greater is desired.

Optical interferometers include two (or more) optical beams. One optical beam is ideally directed along a fixed optical path length, known as the reference path. This beam is known as the reference beam. Another optical beam is directed along a path to a measurement reflector that is connected to an element that may move. This beam is known as the measurement beam, and the path it traverses is known as the measurement path.

In many known optical interferometers, the reference beam and the measurement beam have linear polarization states that are orthogonal to one another (orthonormal direction vectors). Moreover, the frequency of the orthogonal polarization states is purposefully different. The orthogonality of the polarization states allows for the separation of the light from a light source (e.g., a laser head) into the measurement and reference beams, which traverse different optical paths. The orthogonality of the linear polarization states also allows for the recombining of the reference and measurement beams after traversal of their respective light paths.

Once recombined, any differential in phase is measured, normally as a beat frequency. The purposeful differential in the frequency of the beams from the light source provides a baseline beat frequency or differential. Using known signal processing techniques, it is possible to ascertain differentials in measured and reference paths (OPLs) and measure the change in the position of the measurement reflector.

As is known, the OPL is dependent on the index of refraction of the medium through which light travels. In order to provide precise displacement measurements in an interferometer measuring system, the entire path of the measurement and reference beams must exist in a medium (e.g., air) that has a substantially stable index of refraction. Because the index of refraction of a medium may vary with temperature, pressure, humidity and the content of the medium, providing a medium having a substantially stable index of refraction can be difficult.

There is a need for an interferometer that overcomes at least the shortcomings described above.

Defined Terminology

As used herein, the term ‘monolithic’ means comprised of more than two parts, which are fastened together to form a single component; or comprised of a unitary part. For example, a monolithic element may have a plurality of parts fastened together; or may be molded from a material(s) with or without elements embedded in the material(s).

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a side view of an interferometer in accordance with an example embodiment.

FIG. 2A is a perspective view of an interferometer in accordance with an example embodiment.

FIG. 2B is another perspective view of the interferometer in accordance with the example embodiment of FIG. 2A.

FIG. 2C is another perspective view of the interferometer in accordance with the example embodiment of FIG. 2A.

FIG. 2D is a side view of the interferometer of FIG. 2B.

FIG. 3A is a perspective view of an interferometer in accordance with an example embodiment.

FIG. 3B is a side view of the interferometer of FIG. 3A

FIG. 4 is a perspective view of an interferometer in accordance with an example embodiment.

FIG. 5 is a perspective view of an interferometer in accordance with an example embodiment.

FIG. 6 is a perspective view of an interferometer in accordance with an example embodiment.

FIG. 7 is a perspective view of an interferometer in accordance with an example embodiment.

FIG. 8A is a perspective view of an interferometer in accordance with an example embodiment.

FIG. 8B is a side view of the interferometer of FIG. 8A.

FIG. 9A is a perspective view of an interferometer in accordance with an example embodiment.

FIG. 9B is a side view of the interferometer of FIG. 9A.

FIG. 10A is a perspective view of an interferometer in accordance with an example embodiment.

FIG. 10B is a side view of the interferometer of FIG. 10A.

FIG. 11A is a perspective view of an interferometer in accordance with an example embodiment.

FIG. 11B is a side view of the interferometer of FIG. 11A.

FIG. 12A is a perspective view of an interferometer in accordance with an example embodiment.

FIG. 12B is an end view of the interferometer of FIG. 12A.

FIG. 12C is a side view of the interferometer of FIG. 12A.

FIG. 13 is a perspective view of an interferometer in accordance with an example embodiment.

FIG. 14 is a perspective view of an interferometer in accordance with an example embodiment.

FIG. 15 is a perspective view of an interferometer in accordance with an example embodiment.

FIG. 16 is a perspective view of an interferometer in accordance with an example embodiment.

FIG. 17A is a perspective view of an interferometer in accordance with an example embodiment.

FIG. 17B is a side view of the interferometer of FIG. 17A.

### DETAILED DESCRIPTION

In the following detailed description, for purposes of explanation and not limitation, example embodiments disclosing specific details are set forth in order to provide a thorough understanding of embodiments according to the present teachings. However, it will be apparent to one having ordinary skill in the art having had the benefit of the present disclosure that other embodiments according to the present teachings that depart from the specific details disclosed herein remain within the scope of the appended claims. Moreover, descriptions of well-known apparati and methods may be omitted so as to not obscure the description of the example embodiments. Such methods and apparati are clearly within the scope of the present teachings.

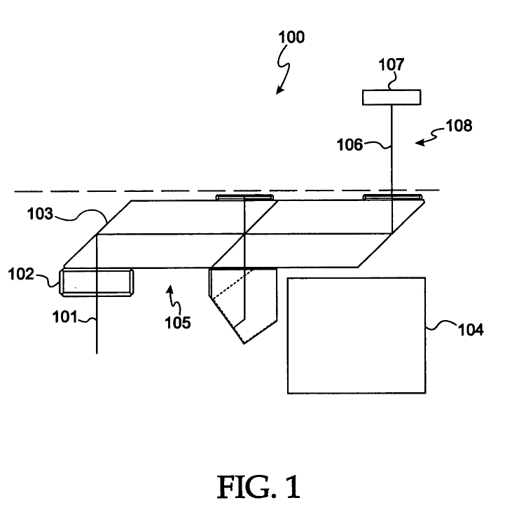

FIG. 1 is a side view of a measurement system 100 in accordance with an example embodiment. An input beam 101 from a laser (not shown) is incident on an optical element 102 adapted to substantially transmit the beam 101 with minimal reflection. Usefully, the optical element 102 has an antireflective (AR) coating to reduce reflection of the incident light. The input beam 101 is reflected from a surface 103 and is rotated by approximately 90° and in a manner similar to a periscope in order to avoid an obstruction 104 that may be a structural element of the measurement system 100.

The input beam 101 is incident on an interferometer 105. A portion of the light 101 is output as a measurement beam 106 and is incident on a measurement reflector 107 that is connected to a structure (not shown). As described in detail herein, the light 106 is useful in exacting a measure of any displacement of the structure from a nominal position.

In the region 108 between the interferometer 105 and the measurement mirror 107, the medium is controlled to provide a substantially stable index of refraction. This control of the medium between the interferometer 105 and the measurement substantially eliminates variance in the index of refraction in the region 108. As can be appreciated, this is useful in preventing variance in the OPL due to factors other than movement of the structure. However, and as noted previously, it can be difficult to control the index of refraction of the medium completely. For example, in the regions near the structure 104 it is difficult to stabilize the index of refraction of the medium. In known measurement systems, this instability can result in measurement errors due to variations in the OPL of the light. By contrast, the interferometer 105 of the example embodiments substantially reduces, if not eliminates the variation in OPL due to variation in the index of refraction of the medium through which the measuring light beams in the region near the structure travel.

The function of the measurement system relies on known electronics (not shown) including, but not limited to a laser head, a tuning circuit, photodetectors and optical elements for routing signals into and out of the measurement system. The measurement and reference light beams are then combined and based on the beat frequency of the combined light beam; a measurement of displacement of the structure is made.

As described in detail herein, the interferometers of the example embodiments allow all light beams outside the interferometer to exist in a volume that has a substantially stable index of refraction.

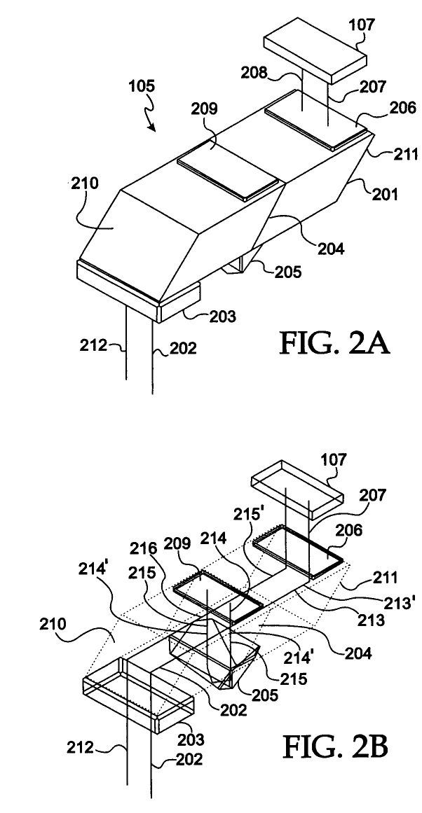

FIG. 2A is a perspective view of the interferometer 105 according to an example embodiment. The interferometer 105 includes a monolithic optical element 201 that receives an input light beam 202 from a laser head (not shown). The input light beam 202 traverses an optical element 203 that includes an anti-reflection coating, and is reflected from a first reflective surface 210. The angle of incidence of light 202 with respect to the surface 210 is illustratively approximately 45°, so that the light 202 is substantially internally reflected and the reflected light is substantially orthogonal to the light 202. In addition, the reflective surface 210 may include a known coating or layer to improve reflection.

The interferometer 105 also includes a polarization beamsplitter (PBS) 204 and a retroreflector 205. The PBS 204 is substantially parallel to the first reflective surface 210. Light traversing the monolithic optical element 201 is incident on a second reflective surface 211 oriented so that the light is incident at approximately 45°. With this arrangement, the light incident in the surface 211 is substantially totally internally reflected as light 207, which is substantially orthogonal to the light incident on the surface 211. It is contemplated that the orientation of the first and second reflective surfaces 210, 211 is other than 45°. However, in specific embodiments the first and second reflective surfaces 210, 211 are substantially parallel.

The light 207 traverses a retarder 206 that is a quarterwave retarder adapted to retard light 207 having a wavelength in vacuum of λ by nλ+λ/4 (n=integer) upon passing through the retarder 206. Beneficially, the retarder includes AR coatings on opposite sides so that light incident thereon is substantially transmitted. The light 207 is reflected by the measurement reflector 107 and traverses the retarder 206 a second time and undergoes a relative phase shift of λ/2. Thus, the light 207 undergoes a halfwave (λ/2) polarization transformation. As such, light that emerges from the monolithic optical element 201 linearly polarized along one axis will reenter the element 201 polarized along a second perpendicular axis.

Light 208 also traverses the element 206, is reflected by the measurement reflector 107, and traverses the element 206 again. Thereby, the light 208 enters the monolithic optical element 201 having a polarization state that is rotated by π/2.

The interferometer 105 includes another retarder 209 disposed over the monolithic optical element 201 and specifically above the PBS 204. Like retarder 206, retarder 209 a quarterwave retarder is adapted to retard light that traverses its width by (nλ+λ/4). However, unlike the retarder 206, retarder 209 has a reflective top surface so the light traverses the retarder 209, is reflected by the top surface and traverses the retarder 209 a second time. Thereby, the light enters the monolithic optical element 201 having a polarization state that is orthogonal to its polarization state upon exiting the monolithic optical element 201.

In accordance with an example embodiment, the monolithic optical element 201 is a rhomboid and may be fabricated in using materials disclosed in and in accordance with the teachings of commonly assigned U.S. Pat. No. 6,542,247 to Bockman. The disclosure of this patent is specifically incorporated herein by reference.

In a specific embodiment, the retarders 206, 209 are multi-layer dielectric stack retarders or birefringent elements such as quartz, mica or an organic polymer having an OPL that provide a retardance of nλ+λ/4 so a halfwave relative phase shift is realized by a double pass through the retarders. In a specific embodiment, the retarders 206,209 are optically contacted to the monolithic optical element; and the retroreflector 205 and the element 203 are secured to the monolithic optical element 201 are adhered using an index matching adhesive material. Accordingly, an optical interface is provided between the retarders 206, 209, the retroreflector 205, the optical element 203, and the monolithic optical element 201. Notably, many optical components in subsequently described example embodiments are optically coupled to the monolithic optical element 201 similarly.

FIG. 2B is a perspective view of the interferometer 105 of an example embodiment. The interferometer 105 is substantially the same as that shown in FIG. 2A, however with the monolithic optical element 201 faintly drawn to show the function of the various components and the light path.

Light 202 is incident on the first surface 210 and is reflected in an orthogonal direction as shown. The light 202 includes two orthogonal linearly polarized light components, each having a specific frequency. Notably, the light components have a frequency difference in the range of approximately 2.0 MHz to approximately 6.0 MHz and an average wavelength of approximately 633 nm. The light 202 may be from a He—Ne laser having a magnetic field applied axially to the laser cavity, which causes Zeeman splitting. Illustratively, the laser may be a component of a laser head such as the 5517 family of laser heads available from Agilent Technologies, Inc., Palo Alto, Calif. USA.

Upon reflection from the first surface, the light 202 is incident on the PBS 204, which transmits light 213 of a first linear polarization state (e.g., p-polarized) and reflects light 214 of a second linear polarization state (e.g., s-polarized). The transmitted light 213 is incident on the second surface 211, which reflects the light through the retarder 206. The light 213 emerges as circularly polarized light 207 and is reflected back through the element 206 by the measurement reflector 107. Thus, the light 213 is transformed into light 213′ having an orthogonal polarization state (e.g., s-polarized) to that of light 213. The light 213′ is reflected from the second surface 211 and is incident on the PBS 204, where it is reflected as light 215 to the retroreflector 205. The retroreflector 205 reflects and displaces the light 215. Upon reflection from the retroreflector, light 215 is incident on the PBS 204, where it is reflected in an orthogonal direction. This light 215 is incident on the second reflective surface 211 and traverses the retarder 206 twice after being reflected by the measurement reflector 107. Because of the polarization transformation caused by the double pass through the element 206, the light 215′ has a polarization state that is rotated by π/2 compared to light 215. As such, light 215′ has a polarization state (p-polarized following the example) that is transmitted through the PBS 204. This component of output light 212 is referred to as the measurement path light because it has traversed the (variable) measurement light path.

Light 214 is reflected from the PBS 204 and traverses the retarder 209 twice upon reflection. The polarization state of light 214 is rotated by π/2 upon traversing the element 209 twice emerging as light 214′. Consistent with the convention of the example, light 214′ is now p-polarized and thus traverses the PBS 204, where it is reflected and displaced by the retroreflector 205. Light 214′ then traverses the PBS 204 and the retarder 209 twice. Upon re-entry into the monolithic optical element 201, light 214′ is transformed to an orthogonal polarization state (e.g., s-polarized). This orthogonally polarized light is reflected by the PBS 204 as light 214 as shown. Because of the polarization transformation provided by the retarder 209, the light 216 traverses the PBS and is combined with light 215′ to form output light 212. The path of the light 216, 214′ is substantially constant and is referred to as the reference path.

FIG. 2C is another perspective view of the interferometer 105. The interferometer is substantially the same as the interferometer shown in FIGS. 2A and 2B, however oriented in an inverted manner. Common details are not provided so as to avoid obscuring the presently described example embodiment.

The interferometer 105 includes the reflective element 205, which is illustratively a retroreflective element. Characteristically, the light that is incident on the retroreflective element at an angle of incidence (with respect to a normal to the retroreflective element) is reflected from the element at substantially the same angle relative to the normal. In a specific embodiment, the reflective element is a cube corner described in detail in commonly assigned U.S. Pat. No. 6,736,518 to Belt, et al. The disclosure of this patent is specifically incorporated herein by reference. The cube corner not only reflects light at an angle substantially equal to the angle of incidence, but also displaces the light by a finite distance. Accordingly, light 214′, 215 are incident at a particular angle (illustratively 0°) and is reflected at substantially the same angle, but is displaced as shown after reflections within the cube corner. It is emphasized that the use of a cube corner is merely illustrative and that other optical components known to those skilled in the art may be used to realize the same result.

As defined above, the monolithic optical element 201 may be comprised of more than two parts, which are fastened together to form a single component; or comprised of an indivisible part. The monolithic optical element 201 may be two substantially identical rhomboids having approximately 45° end-faces. As noted, the rhomboids may be fabricated with and according to the teachings of U.S. Pat. No. 6,542,247. The PBS 204 may be a separate component fastened between two of the end faces with an index matching/anti-reflective adhesive; or may be a coating or plurality of known coatings on an end-face of one of the rhomboids. In the latter embodiment, after the coating(s) is applied, the endfaces are bonded using the index matching/anti-reflective adhesive referenced previously. In yet another embodiment, the monolithic optical element 201 is molded with the PBS 204 embedded in the molded piece.

FIG. 2D is a side-view of the interferometer 105 shown in FIGS. 2A and 2B. Common details are not provided so as to avoid obscuring the present description. The interferometer 105 provides a measurement path and a reference path. The measurement path includes the OPL from the PBS 204 up to the measurement reflector 107. Thus, the measurement path includes the OPL from the PBS 204 and through a second portion 217 of the element 201. Additionally, the measurement path includes the OPL from the second surface 211 through the retarder 206, and the OPL through the medium between the retarder 206 and the measurement reflector 107. Finally, the measurement path includes the traversal through the reflective element 205. Notably, each ‘leg’ of the measurement path is traversed four (4) times.

The reference path includes the OPL from the PBS 204 through the monolithic optical element 201 and through the retarder 209. Thus, the reference path also includes the OPL through a first portion 217 to the reflective element 205 and the OPL through the reflective element 205. Notably, each ‘leg’ of the reference path is also traversed four (4) times.

As is known, the measurement path and the reference path are the same or a known multiple/difference of one another within accepted limits of accuracy. Any difference in the reference and measurement paths results in a change in the beat frequency of the output beam 212 comprised of light components 216, 215′. As such, movement of the measurement reflector 107 indicates movement of the structure to which the reflector 107 of the measurement system 100 is attached. The magnitude of the movement is directly proportional to the difference in the beat frequency and can be quantified by relatively straight-forward calculations using a microprocessor (not shown) of the system 100.

As noted previously, if there is significant variation in the indices of refraction of the various components through which the measurement beam, or the reference beam, or both, travel a variation in the OPL of the measurement path, or the reference path, or both will occur. Ultimately, this reduces the accuracy of the measurements exacted by the interferometer. However, the index of refraction of the monolithic optical element 201 of the example embodiments is substantially immune to variations due to ambient factors, rendering the index of refraction of the monolithic optical element substantially stable. Thus, inaccuracies in measurements from changes in the index of refraction due to an uncontrolled medium are substantially avoided. It is noted that rather slight variations in the OPL of the measurement and reference paths of the interferometer 105 may result from temperature variations. These variations can be used to compensate for other thermally induced measurement errors in the measurement system.

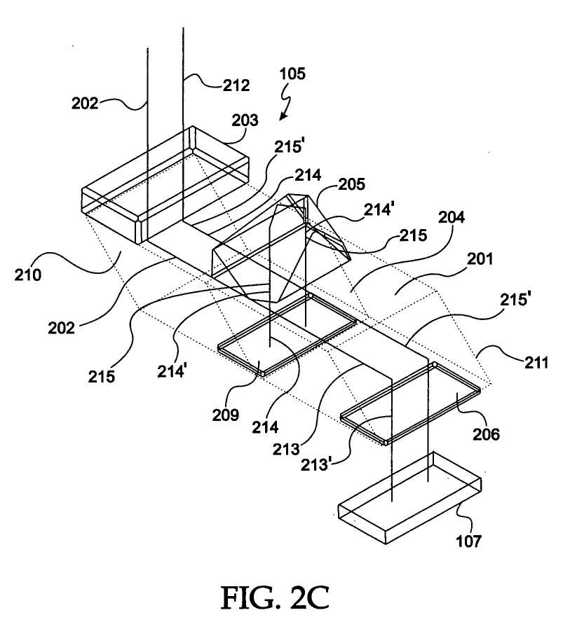

FIG. 3A is a perspective view of an interferometer 301 in accordance with an example embodiment. The interferometer 301 includes many features described in connection with the embodiments of FIGS. 1A-2D and may be used in the measurement system 100. Accordingly, common features are not described in detail to avoid obscuring the presently described embodiments.

The interferometer 301 includes the monolithic optical element 201 having the PBS 204 described previously. Light 202 is incident on the first surface 210 and is reflected toward the PBS 204. The PBS 204 reflects light of one linear polarization state and transmits light of the orthogonal polarization state. Reflected light 302 traverses the retarder 209 and is reflected by the measurement reflector 107. The light reflected from the measurement reflector 107 traverses the retarder 209 a second time and emerges therefrom as light 302′ having an orthogonal linear polarization state to light 302. Because of the polarization transformation, the light 302′ traverses the PBS 204 and is incident on the reflective element 205. The reflective element 205 reflects the light 302′ in a manner described previously, and the light 302′ emerges displaced. The light 302′ then traverses the PBS 204 and the retarder 206 twice after reflection from the measurement reflector 107. Upon entering the monolithic optical element 301 from the retarder 206, the polarization of light 302′ is again rotated and emerges as light 305 having a linear state of polarization that is orthogonal to that of light 302′. Accordingly, the light 302 is reflected by the PBS 204 and comprises one component of the output light 212. Thus, the measurement path includes the OPL just described.

The component of the light 202 having a linear polarization state that is orthogonal to that of light 302 is transmitted by the PBS 204 and emerges as light 303. Light 303 is reflected by the second surface 211 and traverses the retarder 206 twice, having been reflected by a reflective element (e.g., a highly reflective (HR) coating) on the top surface of the retarder 206. As such, the polarization of light 303′ is orthogonal to that of light 303. Light 303′ is then reflected by the PBS 204 to the reflective element 205, where it undergoes reflections and a translation as described. The light 303′ is again reflected by the PBS 204 and is incident on the second surface 211 where it is reflected to the retarder 206. Upon traversing the retarder 206 twice, the linear polarization vector is again rotated by π/2 (or nπ/2) and is reflected by the second surface 211 as light 305. Light 303 is transmitted by the PBS 204 and comprises the second component of the output light 212. As described previously, any movement of the measurement reflector is indicated by a change in the beat frequency of the components 304, 305.

FIG. 3B is a side view of the interferometer 301. The measurement path and the reference path are essentially the same as the reference path and measurement path, respectively, described in connection with FIG. 2D. Accordingly, the description is not repeated in the interest of clarity. However, it is noted that like the interferometer 105 described previously, the interferometer 301 is substantially not susceptible to variations in OPL of either the measurement path or the reference path caused by variations in the index of refraction due to unconditioned air.

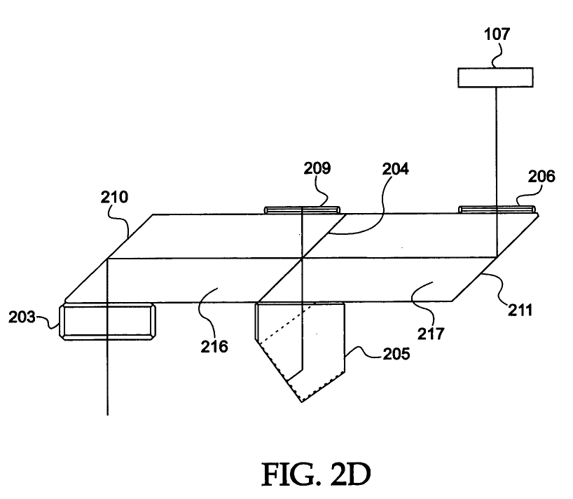

FIG. 4 is a perspective view of an interferometer 401 in accordance with an example embodiment. The interferometer 401 has many common features with the interferometer described in connection with the example embodiments of FIGS. 2A-2D. Accordingly, such details are not repeated so as to avoid obscuring the presently described embodiment. The interferometer 401 receives input light 202 comprising two frequency components having orthogonal states of linearly polarized light; and emits output light 212 comprising two frequency components having orthogonal states of linearly polarized light. As noted previously, variations in the beat frequency are used to exact a measure of the displacement of a measurement reflector.

In the example embodiment, the measurement reflector comprises a first retroreflective element 402, and a second retroreflective element 403. The retroreflective elements 402,403 are adapted to receive light at a particular angle of incidence and reflect the light at substantially the same angle of incidence with substantially no on-axis translation. The first and second retroreflective elements 402, 403 thus comprise the measurement reflector 107 of the interferometer.

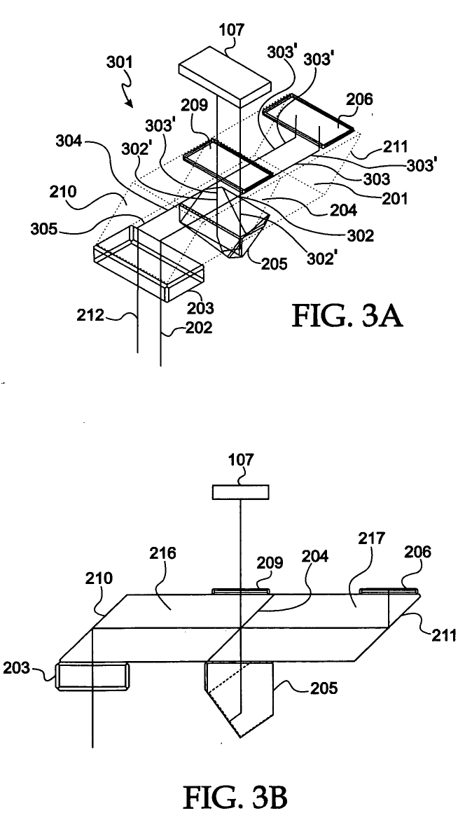

FIG. 5 is a perspective view of an interferometer 501 in accordance with an example embodiment. The interferometer 501 has many common features with the interferometer described in connection with the example embodiments of FIGS. 2A-2D and 4. Accordingly, such details are not repeated so as to avoid obscuring the presently described embodiment. The interferometer 501 receives input light 202 comprising two frequency components having orthogonal states of linearly polarized light; and emits output light 212 comprising two frequency components having orthogonal states of linearly polarized light. As noted previously, variations in the beat frequency are used to exact a measure of the displacement of a measurement reflector.

In the example embodiment, the measurement reflector comprises a retroreflective element 502. The retroreflective element 502 is adapted to receive light at a particular angle of incidence and reflect the light at substantially the same angle of incidence with a set translation. The retroreflective elements 502 thus comprise the measurement reflector 107 of the interferometer.

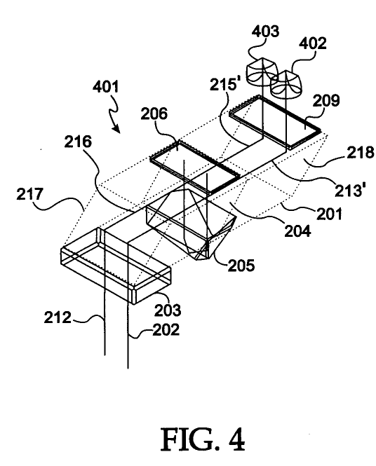

FIG. 6 is a perspective view of a differential interferometer 601 in accordance with an example embodiment. Notably, by separating the reference reflective element(s) from the monolithic optical element 201 of the example embodiments, the interferometer is made into a differential interferometer.

The interferometer 601 has many common features with the interferometers described in connection with the example embodiments of FIGS. 2A-2D, 4 and 5. Accordingly, such details are not repeated so as to avoid obscuring the presently described embodiment. The interferometer 601 receives input light 202 comprising two frequency components having orthogonal states of linearly polarized light; and emits output light 212 comprising two frequency components having orthogonal states of linearly polarized light. As noted previously, variations in the beat frequency are used to exact a measure of the displacement of a measurement reflector.

In the example embodiment, the measurement reflector comprises the first retroreflective element 402, and the second retroreflective element 403. The retroreflective elements are adapted to receive light at a particular angle of incident and reflect the light at substantially the same angle of incidence. The first and second retroreflective elements 402, 403 thus comprise the measurement reflector 107 of the interferometer.

The interferometer 601 also comprises a third retroreflective element 602 and a fourth retroreflective element 603. As can be appreciated, in a differential interferometer, the difference in OPLs of two defined paths is measured. One OPL can be the reference path and the other the measurement. Of course, because a relative measure is provided, it is not necessary that either of OPL be fixed. To this end, the retroreflective elements 402,403 and 602, 603 may be attached to objects that are subject to displacement. Thus, both OPLs are measurement paths. In the interest of consistency of terminology, in the differential interferometers described herein, one path is considered the measurement path and the other is the reference path, even though the reference path is not necessarily fixed. In a specific embodiment, the retroreflective elements 602, 603 are in the reference path and are substantially the same as the first and second retroreflective elements 402,403. In another specific embodiment, the first and second retroreflective elements 402, 403 are in the reference path and the third and fourth retroreflective elements 602,603 are in the measurement path of the interferometer.

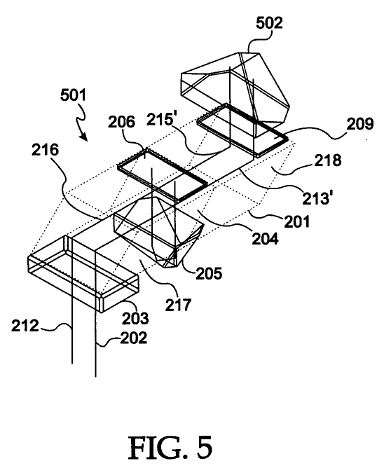

FIG. 7 shows a differential interferometer 701 in accordance with an example embodiment. The interferometer 701 has many common features with the interferometer described in connection with the example embodiments of FIGS. 2A-2D, 5 and 6. Accordingly, such details are not repeated so as to avoid obscuring the presently described embodiment. The interferometer 701 receives input light 202 comprising two frequency components having orthogonal states of linearly polarized light; and emits output light 212 comprising two frequency components having orthogonal states of linearly polarized light. As noted previously, variations in the beat frequency are used to exact a measure of the displacement of a measurement reflector.

In the example embodiment, the measurement reflector comprises the retroreflective element 502. The retroreflective element 502 is adapted to receive light at a particular angle of incident and reflect the light at substantially the same angle of incidence. The retroreflective element 502 thus comprises the measurement reflector 107 of the interferometer.

The interferometer 701 also comprises another retroreflective element 702. In a specific embodiment, the retroreflective element 702 is in the reference path and is substantially the same as the retroreflective element 502. In another specific embodiment, the retroreflective element 502 is in the reference path and the retroreflective element 702 is in the measurement path of the interferometer.

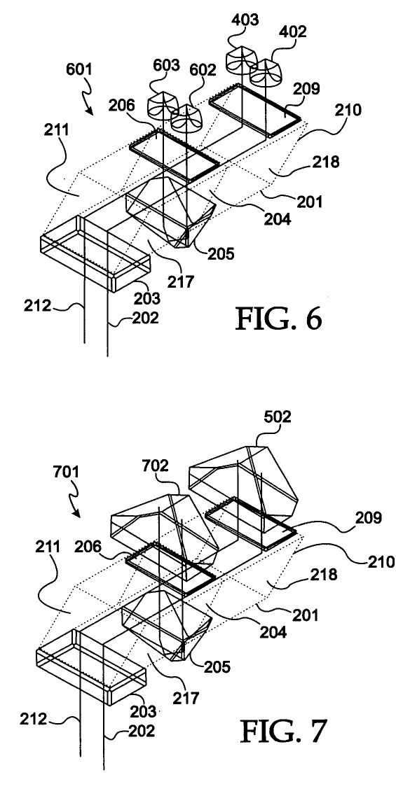

FIG. 8A is a perspective view of an interferometer 801 in accordance with an example embodiment. The interferometer 801 has many common features with the interferometer described in connection with the example embodiments of FIGS. 2A-2D. Accordingly, such details are not repeated so as to avoid obscuring the presently described embodiment. The interferometer 801 receives input light 202 comprising two frequency components having orthogonal states of linearly polarized light; and emits output light 212 comprising two frequency components having orthogonal states of linearly polarized light. As noted previously, variations in the beat frequency are used to exact a measure of the displacement of a measurement reflector.

The interferometer 801 includes a monolithic optical element 802 having the reflective surface 211. The monolithic optical element 802 includes a rhomboid with the PBS 204 oriented as described previously. The monolithic optical element 802 also includes a prism 803 that is optically contacted to or adhered to the PBS 204. Thus, the monolithic optical element 802 includes a rhomboid and a prism. The monolithic optical element 802 is illustrative of the diversity of the applications of the interferometers of the example embodiments. In particular, it may not be necessary for the monolithic optical element to extend as far in certain applications as in others. As such, the interferometer 801 may be implemented with a smaller monolithic optical element.

FIG. 8B is a side view of the interferometer 801. The measurement path length includes the OPL from the PBS 204 to the measurement reflector 107, including the OPL through the retroreflector 205. Notably, in the present embodiment, the polarization component of the input light beam 202 that is reflected by the PBS 204 (e.g., s-polarized light) is reflected into the measurement path. The reference path includes the OPL from the PBS 204 to the reflecting retarder 209, including the OPL through the retroreflector 205. In the present embodiment, the polarization component of the input light beam 202 that is transmitted by the PBS 204 (e.g., p-polarized light) is transmitted into the reference path.

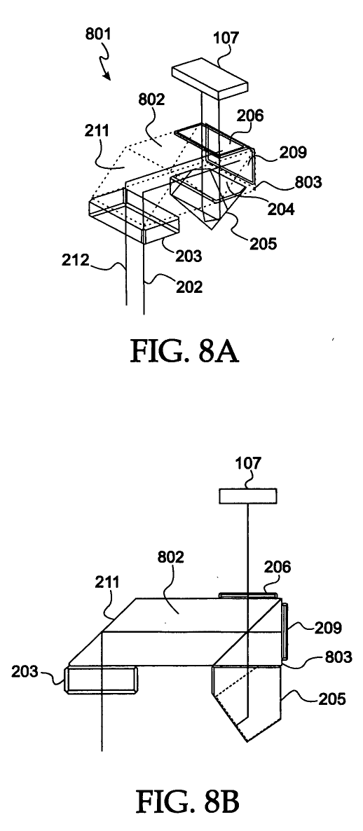

FIG. 9A is a perspective view of an interferometer 901 in accordance with an example embodiment. The interferometer 901 has many common features with the interferometer described in connection with the example embodiments of FIGS. 2A-2D and 8A-8B. Accordingly, such details are not repeated so as to avoid obscuring the presently described embodiment. The interferometer 901 receives input light 202 comprising two frequency components having orthogonal states of linearly polarized light; and emits output light 212 comprising two frequency components having orthogonal states of linearly polarized light. As noted previously, variations in the beat frequency are used to exact a measure of the displacement of a measurement reflector.

The interferometer includes the monolithic optical element 802 described previously. The monolithic optical element 802 is illustrative of the diversity of the applications of the interferometers of the example embodiments. In particular, it may not be necessary for the monolithic optical element to extend as far in certain applications as in others. As such, the interferometer may be implemented with a smaller monolithic optical element.

FIG. 9B is a side view of the interferometer 801. The measurement path includes the OPL from the PBS 204 to the measurement reflector 107 and the OPL through the retroreflector 205. Notably, in the present embodiment, the polarization component of the input light beam 202 that is reflected by the PBS 204 (e.g., s-polarized light) is reflected into the reference path. The reference path includes the OPL from the PBS 204 to the reflecting retarder 209, and the OPL through the retroreflector 205. In the present embodiment, the polarization component of the input light beam 202 that is transmitted by the PBS 204 (e.g., p-polarized light) is transmitted into the measurement path.

Finally, in specific embodiments, many of the retroreflective elements described in connection with FIGS. 4-7 may be included as the reflective elements (e.g., the measurement reflector 107) in the example embodiments of FIGS. 8a-9B.

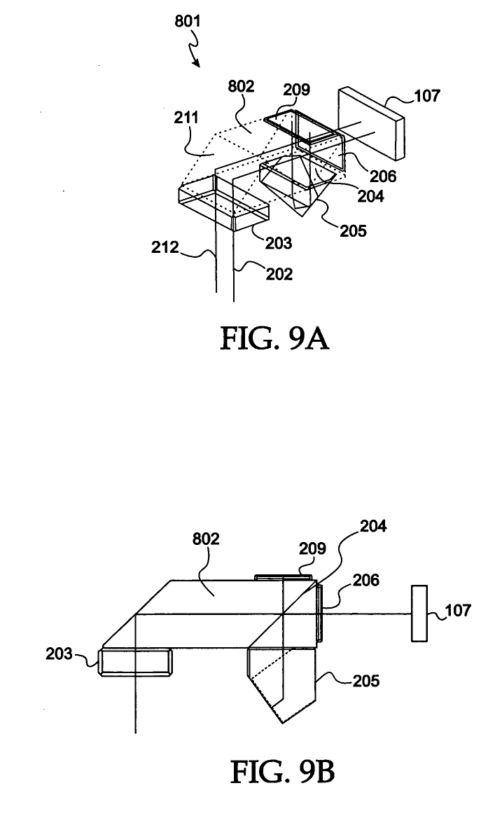

FIG. 10A is a perspective view of a differential interferometer 1001 in accordance with an example embodiment. The interferometer 1001 has many common features with the interferometer described in connection with the example embodiments of FIGS. 2A-2D and 8A-9B. Accordingly, such details are not repeated so as to avoid obscuring the presently described embodiment. The interferometer 1001 receives input light 202 comprising two frequency components having orthogonal states of linearly polarized light; and emits output light 212 comprising two frequency components having orthogonal states of linearly polarized light. As noted previously, variations in the beat frequency are used to exact a measure of the displacement of a measurement reflector.

The interferometer 1001 includes side plates 1002 and a reflective element 1003 that are adhered to the monolithic optical element 802. As such, a monolithic optical element is comprised of all components of the interferometer 1001 with exception of a reflective element 1004 and reflective element 107. The reflective element 1003 is oriented substantially parallel to the first reflective surface 210 so that the light reflected to and from the measurement reflector 107 is substantially reflected. The side plates 1002 may be made of a material having a coefficient of thermal expansion (CFE) on the order of approximately 0.0. Thus, the plates 1002 do not appreciably expand during ambient temperature increases or contract during ambient temperature decreases. Accordingly, the interferometer 1001 is substantially immune to changes in the OPL of either the measurement path or the reference path due to ambient temperature changes.

As shown in FIG. 10B, the measurement path includes the OPL from the PBS 204 to the measurement reflective element 107 and the OPL through the retroreflective element 205. The reference path includes the OPL from the PBS 204 to the reference reflective element 1004 and the OPL through the retroreflective element 205.

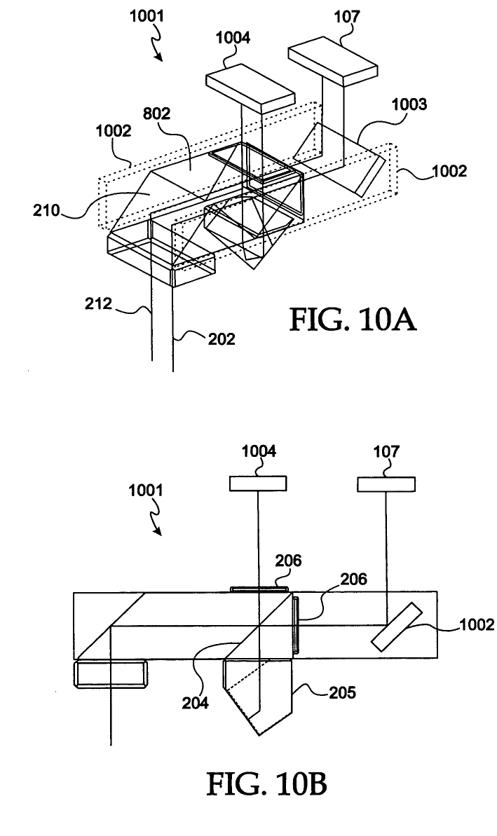

FIG. 11A is a perspective view of a differential interferometer 1101 in accordance with an example embodiment. The interferometer 1000 has many common features with the interferometer described in connection with the example embodiments of FIGS. 2A-2D and 8A-10B. Accordingly, such details are not repeated so as to avoid obscuring the presently described embodiment. The interferometer 1101 receives input light 202 comprising two frequency components having orthogonal states of linearly polarized light; and emits output light 212 comprising two frequency components having orthogonal states of linearly polarized light. As noted previously, variations in the beat frequency are used to exact a measure of the displacement of a measurement reflector.

As shown in FIG. 11B, the measurement path includes the OPL from the PBS 204 to the measurement reflective element 107 and the OPL through the retroreflective element 205. The reference path includes the OPL from the PBS 204 to the reference reflective element 1004 and the OPL through the retroreflective element 205.

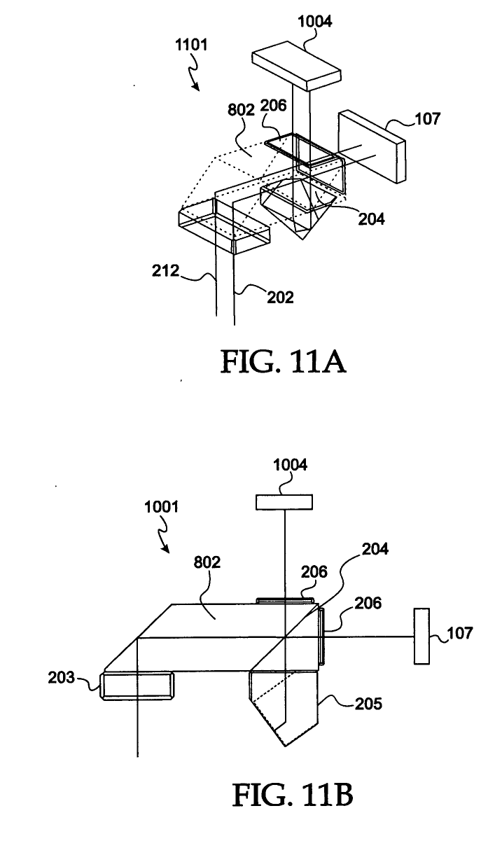

FIGS. 12A, 12B and 12C are a perspective view, an end view and a side view, respectively, of a multi-axis interferometer 1201 in accordance with an example embodiment. The description of the present embodiment is best understood through a concurrent review of FIGS. 12A-12C.

The multi-axis interferometer 1201 receives input light 1202 comprising two frequency components having orthogonal states of linearly polarized light. The light 1202 is incident on a monolithic optical element comprising a rhomboid 1203 and a prism 1204. The light 1202 is incident on a reflective surface 1205 of the rhomboid 1203 and approximately 50% of the light 1202 is reflected and approximately 50% of the light 1202 is transmitted at the interface. A reflected portion 1206 of the light is substantially totally internally reflected at surface 1207 and is reflected into the monolithic optical element 1208. The monolithic optical element 1208 is similar to certain monolithic optical elements described previously. The light 1206 is substantially totally internally reflected at surface 1209 and is incident on a PBS 1210. The PBS 1210 reflects one of the polarization components (p-polarized light), which is light 1211. Light 1211 is incident on the retarder 209. Light 1211 is in the reference path as previously described, is reflected by the retarder 209 and is incident again on the PBS 1210 in an orthogonal polarization state. This light is incident on the retroreflective element 205 and is translated. As described previously, this light is combined with light from the measurement path, which is emitted as output light 1218. The other polarization component of light 1206 is transmitted by the PBS 1210 as light 1212. Light 1212 is incident on a surface 1213 and is substantially totally internally reflected to the retarder 206. This light is then is reflected by the measurement reflective element 1214 back through the retarder 206 and emerges as light 1216. Light 1216 is reflected at the surface 1213 to the PBS 1210, where it is reflected to the retroreflector 205 and is translated. The light 1216 from the measurement path is combined with the light 1211 from the reference path as noted above.

Light 1217 is transmitted at the surface of the rhomboid 1203 and is reflected at surface 1209. Light 1217 also includes orthogonal linear states of polarization. The light 1217 forms the input light and provides the reference light and measurement light in the same manner described above in connection with light 1203. The measurement and reference light beams are combined and emerge as light 1215.

The multi-axis interferometer 1201 is useful in determining any angular displacement of a measured structure. For example, if the measurement reflective element 1214 were a single element attached to a structure under measure and the reflective element 1214 were to rotate (e.g., rotate in the plane of FIG. 12B), the measurement path length for light 1206 would be different than the measurement path length for light 1217. This differential can readily be computed and an angular rotation determined.

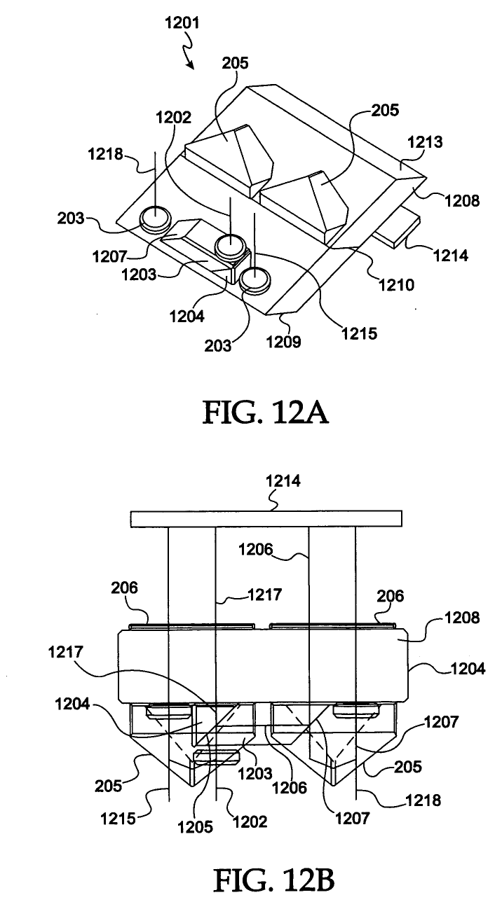

FIG. 13 is a perspective view of a differential interferometer 1301 in accordance with an example embodiment. The interferometer 1301 has many common features with the interferometers described in connection with the example embodiments of FIGS. 2A-2D and 8A-9B. Accordingly, such details are not repeated so as to avoid obscuring the presently described embodiment. The interferometer 1301 receives input light 1302 and input light 1303, each comprising two frequency components having orthogonal states of linearly polarized light. The interferometer 1301 emits output light 212 comprising two frequency components having orthogonal states of linearly polarized light. As noted previously, variations in the beat frequency are used to exact a measure of the displacement of a measurement reflector.

The interferometer 1301 differs from certain embodiments described previously as a single path is provided for each input light beam. In particular, light 1302 is incident on the first reflective surface 210 and is reflected to the PBS 204. The light 1302 is separated into orthogonal linear polarization states 1304, 1305. Light 1304 is reflected into a retroreflective element 1306 and is reflected back onto the PBS with substantially no angular deviation from the angle of incidence on the element 1306. The light 1305 of the orthogonal linear polarization state is transmitted at the PBS 204 and is reflected by the second reflective surface 211 to another retroreflective element 1307. The light 1305 is reflected at element 1307 at substantially the same angle of incidence and is transmitted through the PBS 204. The components 1304 and 1305 are combined to provide a differential in the path lengths traversed.

Light 1303 is similarly separated into orthogonal linear states of polarization by the PBS 204. The details are not repeated so as to avoid obscuring the description of the embodiment.

The differential in OPLs traveled by the states of polarization (e.g., light 1304, 1305) provides a measure of displacement of objects to which retroreflective elements 1306 and 1307 are attached.

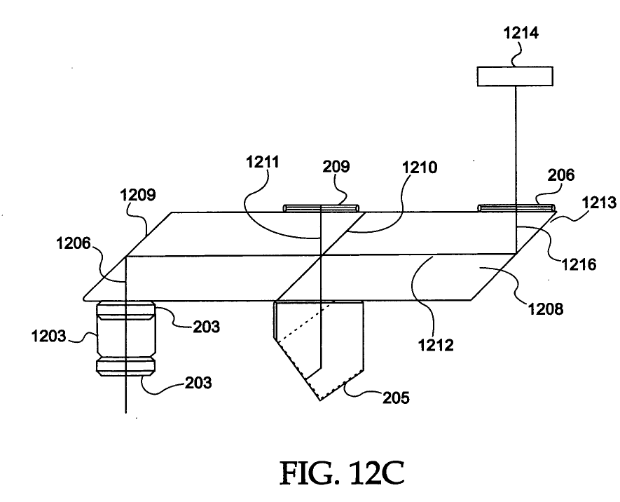

FIG. 14 is a perspective view of an interferometer 1401 in accordance with an example embodiment. The interferometer of the present embodiment is substantially the same as that of the example embodiment of FIG. 13. However, the retroreflective element 1306 is disposed over the monolithic optical element 201 as shown. The light paths to the element 1306 form the reference paths and the light paths to the element 1307 form the measurement paths.

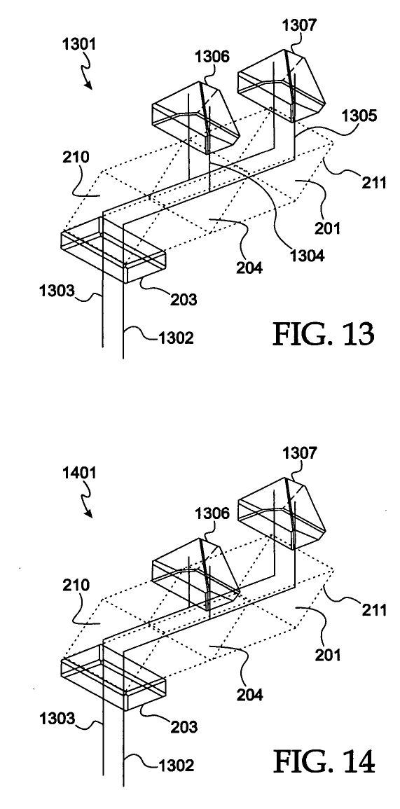

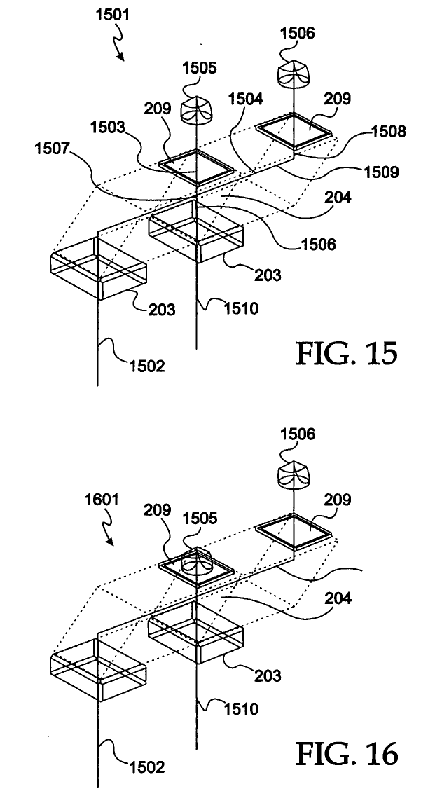

FIGS. 15 and 16 are perspective views of a differential interferometer 1501 and an interferometer 1601, respectively, in accordance with an example embodiment. Light 1502 having orthogonal polarization states is incident on the monolithic optical element 201 as shown. The light 1502 is separated into linear polarization components at the PBS 204, with light 1503 being reflected and light 1504 being transmitted. The light 1503 traverses the retarder 209 and is reflected by a retroreflective element 1505. After traversing the retarder 209 the polarization state of light 1507 is orthogonal to that of light 1503, and light 1507 is transmitted by the PBS 204. Light 1504 is reflected at surface 211, traverses the retarder 209 and is reflected by a retroreflective element 1506. Light 1509 emerges from the retarder 209 and is reflected by the PBS 204. Light 1509 is combined with light 1507 to form output light 1510 which is used to exact measurements of the difference in the OPL of each component.

The interferometer 1601 is substantially the same as the interferometer 1501. However, the retroreflective element 1505 is disposed over the monolithic optical element 201 as shown. The light path to the element 1505 forms the reference path and the light path to the element 1506 forms the measurement path.

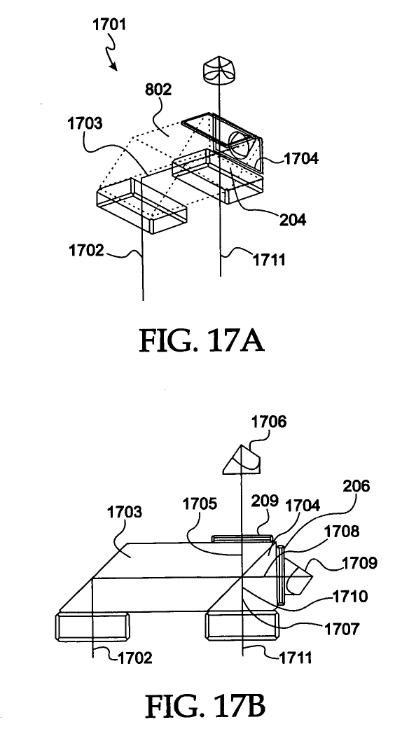

FIGS. 17A and 17B are perspective and side views, respectively, of an interferometer 1701 in accordance with an example embodiment. The interferometer 1701 has many common features with the interferometers described in connection with the example embodiments of FIGS. 2A-2D and 8A-8B. Accordingly, such details are not repeated so as to avoid obscuring the presently described embodiment. The interferometer 1701 receives input light 1702 comprising two frequency components having orthogonal states of linearly polarized light; and emits output light 1711 comprising two frequency components having orthogonal states of linearly polarized light. As noted previously, variations in the beat frequency are used to exact a measure of the displacement of a measurement reflector.

Light 1702 is separated into orthogonal linear polarization states by the PBS 204 disposed between rhomboid 1703 and a prism 1704. The light 1705 is reflected and traverses the retarder 209, and is reflected by a retroreflector 1706. After traversing the retarder again, light 1707 is transmitted by the PBS 204. Light 1708 is transmitted by the PBS 204 and traverses the retarder 206 and is reflected by a retroreflector 1709. Light 1710 emerges from the retarder 209 and is reflected by the PBS 204. Light 1707 and light 1710 are combined to form an output beam 1711. As can be appreciated, the measurement path includes the OPL of light 1705 and light 1707; and the reference path includes the OPL of light 1708 and light 1710.

In accordance with illustrative embodiments described, an interferometer is useful in measurement systems. One of ordinary skill in the art appreciates that many variations that are in accordance with the present teachings are possible and remain within the scope of the appended claims. These and other variations would become clear to one of ordinary skill in the art after inspection of the specification, drawings and claims herein. The invention therefore is not to be restricted except within the spirit and scope of the appended claims.

1. An optical interferometer, comprising:
a monolithic optical element having a polarization beamsplitter (PBS) and at least one reflective surface substantially parallel to the PBS.

2. An optical interferometer as recited in claim 1, wherein the monolithic optical element further comprises a retro-reflective element adapted to reflect incident light substantially parallel to an incident path and offset from the incident path.

3. An optical interferometer as recited in claim 1, wherein the monolithic optical element further comprises a first portion and a second portion and the PBS is disposed between the first portion and the second portion.

4. An optical interferometer as recited in claim 1, further comprising at least one other reflective surface substantially parallel to the PBS.

5. An optical interferometer as recited in claim 4, wherein the PBS is disposed between the reflective surfaces.

6. An optical interferometer as recited in claim 2, wherein the retro-reflective element is a cube corner.

7. An optical interferometer as recited in claim 1, further comprising a reference reflective element disposed over the monolithic optical element.

8. An optical interferometer as recited in claim 7, further comprising quarterwave retarder disposed between the monolithic optical element and the reference reflective element.

9. An optical interferometer as recited in claim 3, wherein the first portion is a rhomboid.

10. An optical interferometer as recited in claim 3, wherein the first portion is a rhomboid and the second portion is a rhomboid.

11. An optical interferometer as recited in claim 10, further comprising quarterwave retarder disposed between the monolithic optical element and a measurement reflective element.

12. An optical interferometer as recited in claim 11, wherein the measurement reflective element comprises at least one retro-reflective element adapted to reflect incident light substantially parallel to an incident path.

13. An optical interferometer, comprising:
a monolithic optical element having a first surface and a second surface, wherein the first surface is not parallel to the second surface.

14. An optical interferometer as recited in claim 13, wherein the monolithic optical element further comprises a retro-reflective element adapted to reflect incident light substantially parallel to an incident path and offset from the incident path.

15. An optical interferometer as recited in claim 13, wherein the monolithic optical element further comprises a polarization beamsplitter (PBS) disposed between the first surface and the second surface.

16. An optical interferometer as recited in claim 15, wherein the monolithic optical element further comprises a first portion and a second portion and the PBS is disposed between the first and second portions.

17. An optical interferometer as recited in claim 16, wherein the first portion comprises a rhomboid and the second portion comprises a prism.

18. An optical interferometer as recited in claim 13, further comprising a measurement reflective element disposed over the monolithic optical element.

19. An optical interferometer as recited in claim 18, further comprising a quarterwave retarder disposed between the monolithic optical element and the measurement reflective element.

20. An optical interferometer as recited in claim 13, further comprising a reference reflective element disposed over the monolithic optical element.
